(19) United States
(12) Patent Application Publication
(10) Pub. No.: US 2005/0149846 A1
(43) Pub. Date: Jul. 7, 2005

(54) Apparatus, method, and program for text classification using frozen pattern

(76) Inventors: Hiroyuki Shimizu, Tokyo (JP); Shinya Nakagawa, Tokyo (JP)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/958,598

(22) Filed: Oct. 6, 2004

(30) Foreign Application Priority Data
Oct. 7, 2003 (JP) 2003-348600

(51) Int. Cl. G06F 15/00; G06F 17/00; G06F 17/21; G06F 17/24; G06N 5/02

(52) U.S. Cl. 715/500; 706/46

(57) ABSTRACT

A document is classified by document style on the basis of textual analysis without depending upon morphological analysis. A style-specific frozen pattern is prepared as a reference dictionary for each document style. A frozen pattern list is extracted for an input document based on the basis of a state of appearance of a style-specific frozen pattern present in the document. Confidence for each document style is calculated based on the frozen pattern list and the detected style of the input document.

### TECHNICAL FIELD

The present invention relates to a method, apparatus, and a storage device or storage medium storing a program for causing a computer to classify a document for each document style using frozen patterns included in the document.

### BACKGROUND ART

A large number of methods have been proposed to extract information from a large quantity of electronic documents. However, there are various document styles, such as a (1) formal written document having grammatically correct sentences, e.g., a newspaper article, (2) a somewhat informal document having sentences or the like that can be understood but are not grammatically correct and often include the spoken language, e.g., a comment on an electronic bulletin board, and (3) a hurriedly written very informal document like a daily report. Because there is, to our knowledge, no document processing technique that can consistently handle those documents of various document styles, it is necessary to select a document processing technique suitable for each document style. Therefore, it is necessary to classify documents for each document style.

A known document classification method classifies documents on the basis of statistical information of words appearing in the documents. For example, JP 6-75995 A and the like disclose a method of using frequencies of appearance or the like of respective keywords in documents belonging to categories as relevance ratios to the categories. The relevance ratios of words appearing in an input document for each category are added or otherwise combined to calculate a relevance ratio to each category. The input document is classified into a category having a largest relevance ratio. In JP 9-16570 A, a decision tree for deciding a classification is formed in advance on the basis of the presence or absence of document information. The decision tree uses keywords decide a classification. In JP 11-45247 A, the similarity between an input document and a typical document in a category is calculated to classify the input document. Other prior art non-patent references of the interest are: JP 6-75995 A; JP 9-16570 A; JP 11-45247 A; “Natural Language Processing” (Edited by Makoto Nagao et al., Iwanami Shoten); J. Ross. Quinlan, “C4.5: Programing for machine learning” Morgan Kaufman Pubiliser (1993)); “A decision-theoretic generalization of on-line learning and an application to boosting.” (Yoav Freund and Robert Schapire, Journal of Computer and System Sciences, 55(1): 119-139, 1997).

In these methods, a document is divided into word units. As a result, in order to acquire a keyword, it is necessary to apply natural language processing, such as morphological analysis, to a document that is not “written word by word” such as a document in Japanese or Chinese.

However, since documents have various document styles such as a newspaper article, a thesis, and an e-mail, it is difficult to accurately resolve into word units in documents of the various document styles, even if the natural language processing is applied to the documents by using a dictionary or the like because of different degrees of new words, abbreviations, errors in writing, grammatical errors, or the like. In addition, since these methods mainly use a word, such as a noun or keyword., to indicate content, the methods are suitable for classifying documents by topic. However, the prior art methods are not suitable for classifying documents by document style, such as classifying input documents into a newspaper article style, a comment style and so on.

### SUMMARY OF THE INVENTION

It is an object of the present invention to provide a new and improved apparatus for and method of classifying a document by document style, on the basis of document style information, rather than by topic.

It is another object of the invention to realize document classification based on textual analysis without depending upon morphological analysis.

In a set of documents having the same document style, common characteristic patterns are found in expressions, ends of words, and/or the like. In accordance with an aspect of the present invention, frozen patterns that frequently appear in each document style in this way (hereinafter referred to as style-specific frozen patterns) are prepared as a reference dictionary for each document style. A frozen pattern list is extracted for an unclassified input document on the basis of an appearance state of style-specific frozen patterns present in the document. Confidence is calculated for each document style on the basis of the frozen pattern list. A document style to which the input document belongs is determined on the basis of the confidence to classify the document.

As described above, according to one aspect of the present invention, classification according to document style is realized rather than classification according to each document topic. Document processing suitable for a specific document style is selected by classifying documents for each document style. Since a frozen pattern is an expression specific to a document style, there is an advantage that the frozen pattern is less likely to be affected by unknown words, coined words, and the like that generally cause a problem in document classification.

The above and still further objects, features and advantages of the present invention will become apparent upon consideration of the following detailed descriptions of the specific embodiment thereof, especially when taken in conjunction with the accompanying drawings.

### BRIEF DESCRIPTION OF THE DRAWING

FIG. 1 is a schematic diagram of a document classification apparatus including a preferred embodiment of the invention.

FIG. 2 is a schematic diagram of an information extractor of a frozen pattern.

FIG. 3 is a schematic diagram of a document classifier.

FIG. 4 is a diagram of an exemplary document style decision tree that decides whether a document belongs to document style 1 or other document styles.

FIG. 5 is a diagram exemplary of a decision tree for a document style to be determined, wherein the tree assists in deciding whether a document belongs to document style 2 or other document styles.

FIG. 6 is a diagram of exemplary style-specific frozen patterns that are divided into cluster 1 and cluster 2.

FIG. 7 is a diagram of an exemplary decision tree for document style, wherein the tree decides whether a document belongs to document style 2 or the other document styles, wherein document style 2 is divided into sub-clusters.

FIG. 8 is a flowchart of a document classification algorithm according to a preferred embodiment of the present invention.

FIG. 9 is a diagram of an apparatus for performing a preferred embodiment of the present.

### DETAILED DESCRIPTION OF THE DRAWING

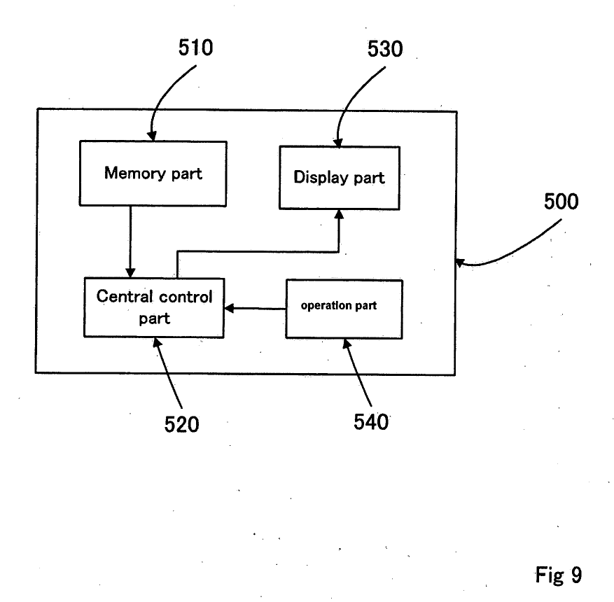

FIG. 9 is a diagram of an apparatus including housing 500 for a processor arrangement including memory 510, central processing unit (CPU) 520, display part 530, and input/output unit 540. A user inputs necessary information into input/output unit 540. The central processing unit 520 responds to the information from unit 540 to read out information stored in the memory 510 to perform predetermined processing and calculations on the basis of the inputted information and displays the result of the processing and calculations on the display 530.

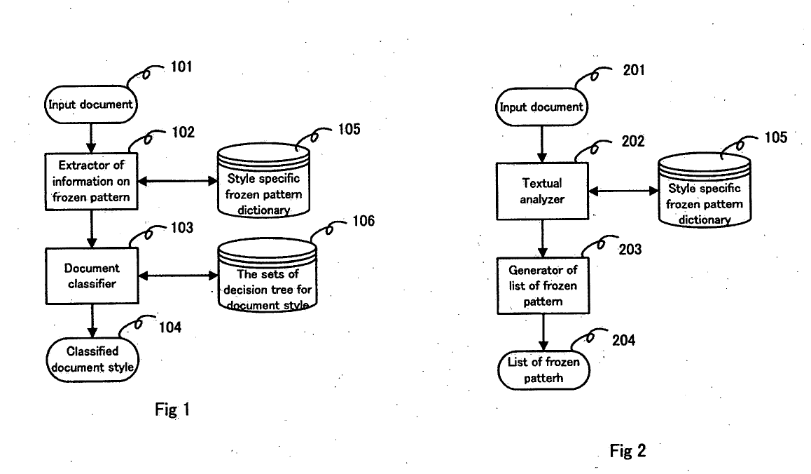

FIG. 1 is a schematic block diagram of a document classifier including a style-specific frozen pattern dictionary 105, sets 106 of decision trees for document style, an extractor 102 of information of a frozen pattern, and a document classifier 103. The style-specific frozen pattern dictionary 105 stores style-specific frozen patterns for enabling extraction of a style-specific frozen pattern. The sets 106 of decision trees for document style store classification rules for document styles. The extractor 102 of information on frozen pattern extracts style-specific frozen patterns, which are included in an input document. The extractor extracts the pattern from the document and converts the style-specific frozen patterns into a form of a frozen pattern list. The document classifier 103 decides the document style of the input document from the frozen pattern list by using a decision tree stored in the sets 106 of decision tree for document style.

Examples of the document style classifications are (1) an introductory article that is a written grammatically correct document, (2) an electronic bulletin board that is a document in a spoken language, (3) a daily report that is a hurriedly written document. In this specification, the document style of an introductory article (document style 1) and the document style of an electronic bulletin board (document style 2) are examples of document styles that are to be classified.

FIG. 2 is a block diagram of the extractor 102 of information of frozen pattern 102 of FIG. 1. The extractor 102 of information of frozen pattern 102 includes a textual analyzer 202 that extracts style-specific frozen patterns present in an input document and a generator of a list of frozen patterns 203. Extractor 102 converts the input document into a frozen pattern list. The textual analyzer 202 applies textual collation processing to each sentence of the input document while referring to the style-specific frozen pattern dictionary 105 (FIG. 1) to thereby extract a style-specific frozen pattern present in the sentence. Then, the generator 203 of a list of frozen patterns converts each sentence of the input document into a frozen pattern list for each document style from the style-specific frozen patterns extracted by the textual analyzer 202.

The style-specific frozen patterns are stored for each document style in the style-specific frozen pattern dictionary which is referred to by the textual analyzer 202. An example of style-specific frozen patterns stored in the style-specific frozen pattern dictionary for the document style 1 is shown in Table 1 below.

TABLE 1

[symbol]

[symbol]

[symbol]

[symbol]

[symbol]

[symbol]

Next, an example of style-specific frozen patterns stored in the style-specific frozen pattern dictionary 105 for document style 2 is shown in Table 2.

TABLE 2

[symbol]

[symbol]

[symbol]

[symbol]

[symbol]

[symbol]

[symbol]

Style-specific frozen patterns to be stored in the style-specific frozen pattern dictionary 105 are automatically extracted from a set of documents. The documents are classified in advance for each document style. The classified documents are stored as the style-specific frozen pattern dictionary 105.

The first step of the extraction method is to extract, from a set of documents, character strings with a high frequency among character strings of an arbitrary length. The extracted strings are considered to be candidate strings. A method of efficiently calculating a frequency statistic of character strings of an arbitrary length is described in detail in “Natural Language Processing” (edited by Makoto Nagao, et al., Iwanami Shoten). Then, for each candidate string, the front side entropy E_{f} of the candidate strings is calculated from a character set (W_{f}={w_{f1}, w_{f2}, . . . , w_{fn}} adjacent to the front of the candidate string, while a rear side entropy Eᵣ of the candidate strings is calculated from a character set (Wᵣ={wᵣ₁, wᵣ₂, . . . , wᵣₘ)} adjacent to the rear of the candidate string. The calculations of W_{f} and Wᵣ are in accordance with Expressions (1)-(4).

$$\begin{matrix}\text{Expression 1} & \\ {E}_{f} = - {\sum }_{i = 1}^{i <= n} {P}_{f} ( S , {w}_{fi} ) \times log {P}_{f} ( S , {w}_{fi} ) & ( 1 ) \\ \text{[Expression 2]} & \\ {E}_{r} = - {\sum }_{i = 1}^{i <= m} {P}_{r} ( S , {w}_{ri} ) \times log {P}_{r} ( S , {w}_{ri} ) & ( 2 ) \\ \text{Expression 3} & \\ {P}_{f} ( S , {w}_{fi} ) = \frac{f ( {w}_{fi} S )}{f ( S )} & ( 3 ) \\ \text{Expression 4} & \\ {P}_{r} ( S , {w}_{n} ) = \frac{f ( {Sw}_{fi} )}{F ( S )} & ( 4 )\end{matrix}$$

In Expressions (1)-(4), S is a candidate string, f(S) is the number of times a candidate string appears, f(w_{fi}S) is the number of times a character string w_{fi}S in which w_{fi} is adjacent to the front of S, and f(Swᵣᵢ) is the number of appearances of a character string Swᵣᵢ in which wᵣᵢ is adjacent to the rear of S. The entropy expression (1) has a large value if the character string S is adjacent to various characters in front of the string and there is an equal occurrence probability; that is, if there is a boundary of expression in the front of the character string. Conversely the character string has a small value if there are fewer kinds of characters to which the character string S is adjacent and an occurrence probability has a bias; that is, if the character string S is a part of a larger expression including an adjacent character. Similarly, the entropy of expression (2) has (1) a large value if there is an expression boundary in the rear of the character string S and (2) a small value if the character string S is a part of a larger expression. Then, only a candidate string having both front and rear entropies larger than an appropriate threshold value is extracted as a style-specific frozen pattern.

Table 3 is an example of candidate strings obtained from a set of documents belonging to the document style 1 and entropies thereof, while Table 4 is an example of candidate strings obtained from a set of documents belonging to the document style 2 and entropies thereof.

TABLE 3

| Candidate string | Entropy (front) | Entropy (rear) |
|---|---|---|
| [symbol] | 2.464508 | 2.499022 |
| [symbol] | 2.458311 | 2.098147 |
| [symbol] | 2.019815 | 2.019815 |
| [symbol] | 1.791759 | 1.56071 |
| [symbol] | 1.94591 | 1.747868 |
| [symbol] | 1.386294 | 1.386294 |

TABLE 4

| Candidate string | Entropy (front) | Entropy (rear) |
|---|---|---|
| [symbol] | 2.813899 | 2.78185 |
| [symbol] | 2.273966 | 2.512658 |
| [symbol] | 1.747868 | 1.475076 |
| [symbol] | 1.427061 | 1.889159 |
| [symbol] | 1.337861 | 1.580236 |
| [symbol] | 1.098612 | 1.098612 |

The generator 203 of a list of frozen pattern generates a frozen pattern list for each sentence. For example, in the case in which an input document has N sentences and there are M document styles that should be classified, N×M frozen pattern lists are generated from the generator 203 of list of frozen pattern. Each frozen pattern list to be generated is a list in which style-specific patterns appearing in each sentence among style-specific frozen patterns stored in the style-specific frozen pattern dictionary 105 are enumerated for each document style. In this document, [symbol] [symbol] [symbol] Joi'x.” will be considered as inputted example sentence 1. Table 5 is a frozen pattern list for document style 1 and document style 2 at the timer the inputted example sentence 1.

TABLE 5

| | |
|---|---|
| Document style 1: | {} |
| Document style 2: | { [symbol] } |

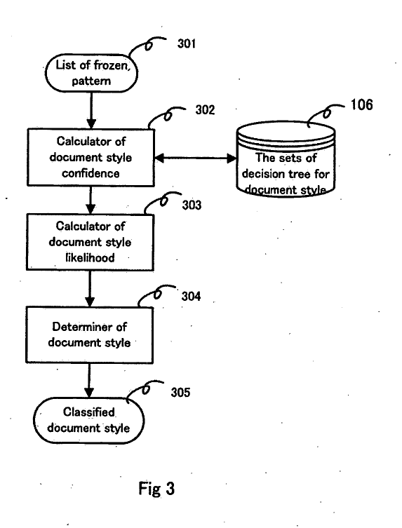

FIG. 3 is a block diagram of the document classifier 103. The document classifier 103 includes a calculator 302 of document style confidence that calculates confidence of each document style (document style confidence) using a decision tree (decision tree for document style), a calculator 303 of document style likelihood that calculates likelihood for each document style (document style likelihood) from the document style confidence, and a determiner 304 of document style that determines a document style of an input document from the document style likelihood.

A decision tree for document style is stored for each document style in sets of decision trees for document style that are referred to by the calculator 302 of document style confidence. The document style decision tree has a style-specific frozen pattern, which is extracted for each document style, as a characteristic and finds a classification of the document style and confidence at that point. There are two classes of document styles to be classified by the decision tree for document style. For example, in the case of the decision tree for document style 1, the classes are document style 1 and other document styles. The decision tree for document style is learned from a set of documents classified for each document style.

A decision tree algorithm generates classification rules in a form of a tree on the basis of an information theoretical standard from a data set having characteristic vectors and classes. Structuring of the decision tree is performed by dividing the data set recursively according to a characteristic. Details of the decision tree are described in J. Ross. Quinlan, “C4.5: Programing for Machine Learning” Morgan Kaufman Pubiliser (1993) and the like. Using the same method, for example, a decision tree for document style for the document style 1 is constructed by producing a data se represented by a characteristic vector, which is characterized by the style-specific frozen pattern of the document style 1, and a class to which the document style 1 belongs (document style 1/anoher document style).

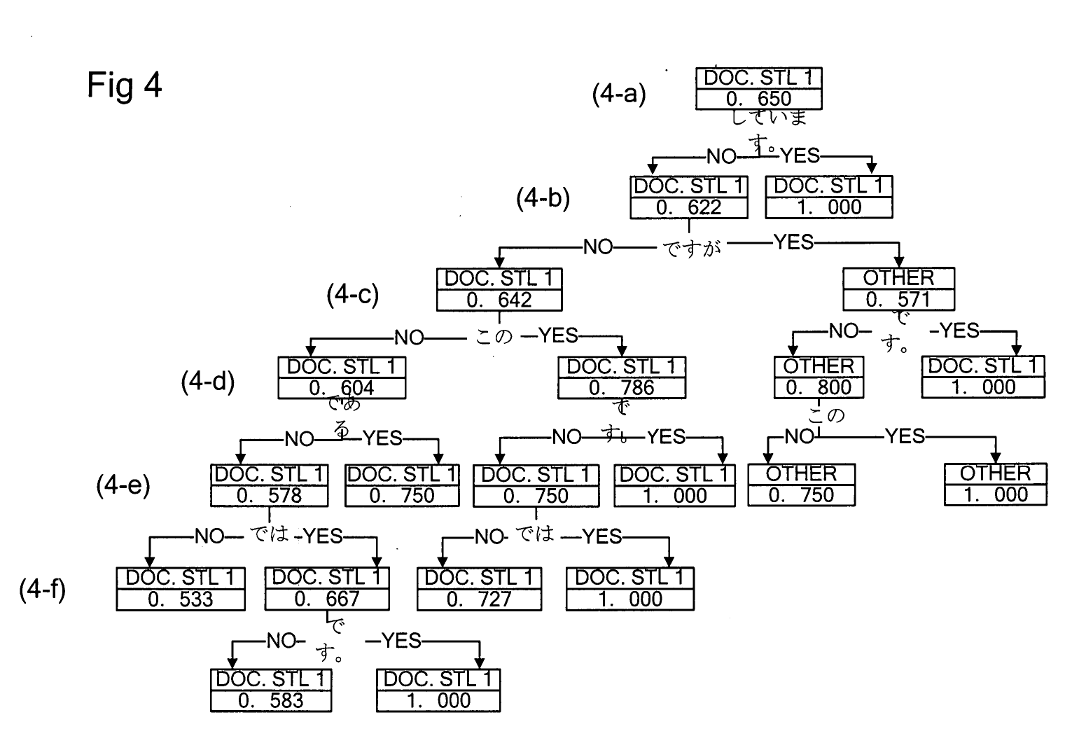

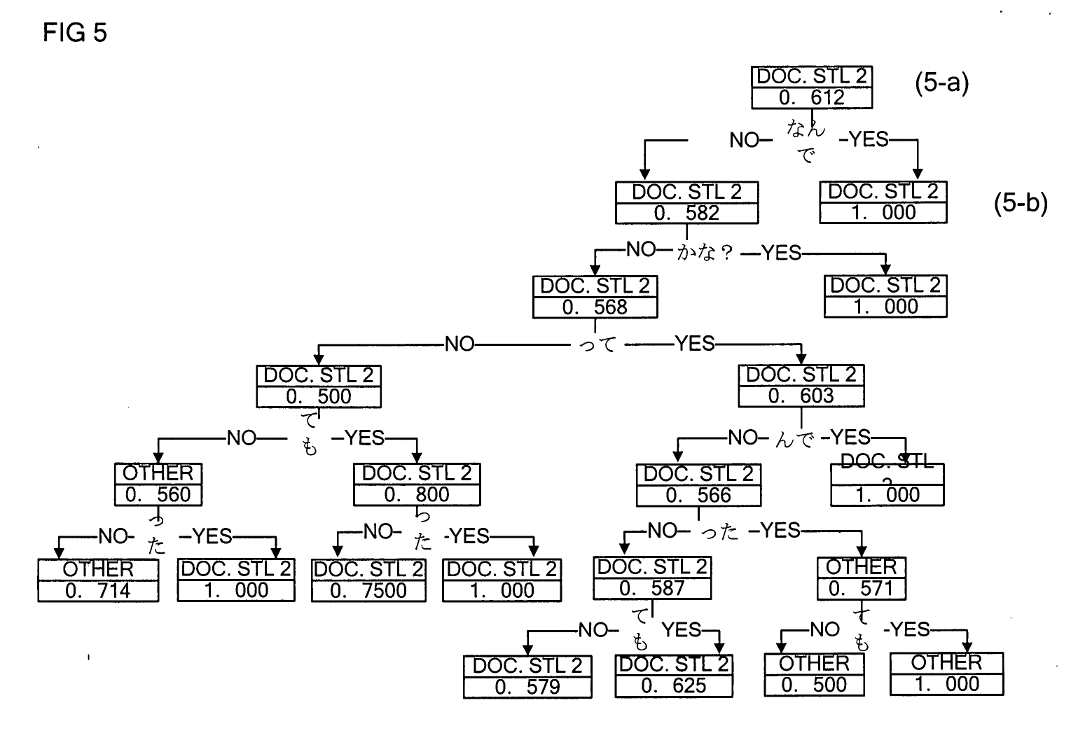

FIG. 4 is a diagram of a document style decision tree for classifying a document into document style 1 or the other document styles with the style-specific frozen pattern (Table 1) for the document style 1 as a characteristic. FIG. 5 is a diagram of a document style decision tree for classifying a document into the document style 2 or the other document styles with the style-specific frozen pattern (Table 2) for the document style 2 as a characteristic. The frozen pattern shown below each node in FIGS. 4 and 5 represents a characteristic that is used for classifying data allocated to each node. YES/NO affixed to each branch represents a value of a characteristic corresponding to a classification of the data. The value shown in the upper half of the part of a node/leaf represents a class to which data allocated to the node/leaf belongs. In addition, the value shown in the lower half of the part of a node/leaf represents the probability (confidence) of data. The value is calculated using a class frequency distribution of data allocated to each node/leaf belonging to the class represented in the upper half of the node/leaf. In the case of a bifurcated branch not extending downward from each block, the block is called a “leaf”. In the case of a bifurcated branch extending from each block, the block is called a “node”.

A document style to which an inputted sentence belongs, and confidence at that point can be found using the document style decision trees of FIGS. 4 and 5. The result of a document style and confidence obtained from each decision tree for document style with respect to the inputted example sentence 1 [symbol] [symbol] [symbol] Joi'x.” is shown in Table 6.

TABLE 6

| | | Decision tree | |
|---|---|---|---|
| | List of frozen | for document | |
| | pattern | style | Confidence |
| Document style 1 | {} | | 0.533 |
| Document style 2 | { [symbol] | | 1.000 |
| | [symbol] } | | |

Since the inputted exemplary sentence 1 does not include any style-specific frozen pattern for document style 1, document style 1 is obtained as a class to which the inputted example sentence 1 belongs; 0.533 is obtained as the confidence from the decision tree for document style for the document style 1 in FIG. 4 on the basis of a leaf (FIG. 4: (4-f)) finally reached by tracking branches with a value of having a “NO” characteristic (FIG. 4: (4-a)→(4-b)→(4-c)→(4-d)→(4-e)→(4-f)). In addition, since the inputted example sentence 1 includes style-specific frozen patterns [symbol] [symbol] for the document style 2, the document style 2 can be found as a class to which the inputted exemplary sentence 1 belongs and 1.00 is found as confidence from the decision tree for document style for the document style 2 in FIG. 5 on the basis of a leaf (FIG. 5: (5-b)) finally reached by tracking branches with a value for [symbol] of “YES” (FIG. 5: (5-a)→(5-b)).

For example, in the case of the decision tree for document style for the document style 1 in FIG. 4, since a document is classified into the document style 1 or the other document styles, and confidence for the classified document style is given, confidence for the document style 1 is not obtained from the decision tree for document style if the document is classified into the other document styles. Therefore, if the document is classified into the other document styles, confidence C′ for the document style 1 is calculated using confidence C for the other document styles and C′ is used as the confidence value for the document style 1.

Expression 5
C′=1−C (5)

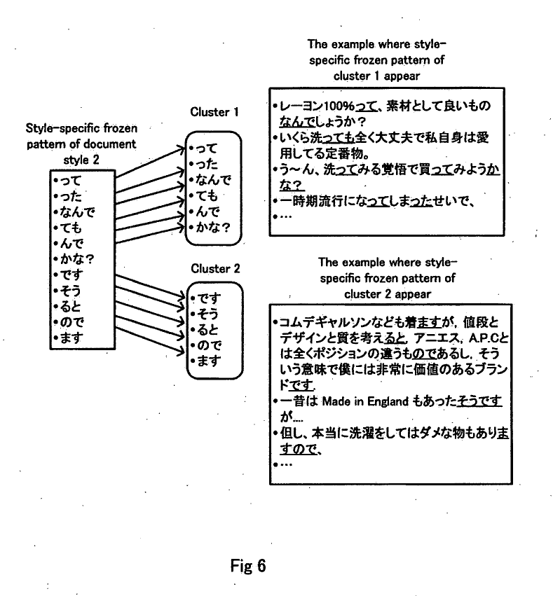

Table 6 is an example of confidence for the inputted example sentence 1. In Table 6, with respect to the inputted sentence 1, document style 1 confidence is calculated using the decision tree for document style of FIG. 4, and document style 2 confidence is calculated using the document style decision tree of FIG. 5. The inputted example sentence 1 is a sentence in document style 2. Confidence for the document style 2 is higher than the confidence for the document style 1, as shown by the result in FIG. 6. However, in general, it cannot be considered that classification performance by only one decision tree is high. A known method of improving the classification performance includes combining plural classifiers, such as decision trees, in the field of machine learning.

Details of a method of combining plural classifiers are described in “A decision-theoretic generalization of on-line learning and an application to boosting.” (Yoav Freund and Robert Schapire, Journal of Computer and System Sciences, 55(1): 119-139, 1997. A similar method is used in the classifier of FIGS. 1-9 and can be expected to improve the classification performance of a document style by preparing document style plural decision trees for each document style. More specifically, style-specific frozen patterns for the same document style are grouped into plural clusters. A document style decision tree is learned for each group, with style-specific frozen patterns belonging to the group as characteristics. Plural document style decision trees are prepared for each document style. As a grouping method, since style-specific frozen patterns extracted from a set of documents of the same document style include style-specific frozen patterns that are likely to appear in the same document as a certain style-specific frozen pattern and style-specific frozen patterns that are less likely to appear in the document, the style-specific frozen patterns are grouped by performing clustering among the style-specific frozen patterns that are likely to appear in the same document. FIG. 6 is a diagram of an example of clusters obtained by grouping the style-specific frozen patterns of document style 2 into the style-specific frozen patterns that are likely to appear in the same document.

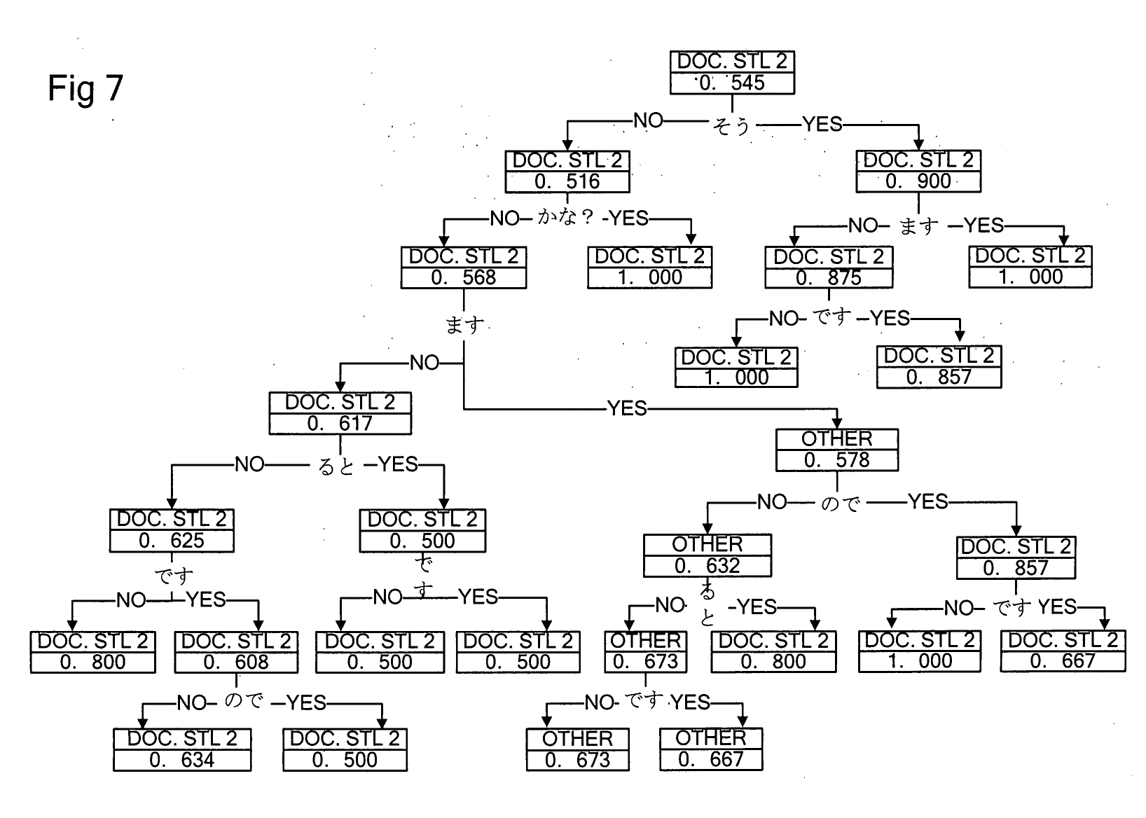

The decision tree shown in FIG. 5 is a document style decision tree that is learned with style-specific frozen patterns belonging to cluster 1 of FIG. 6 as characteristics. Then, a document style decision tree is formed with style-specific frozen patterns belonging to the grouped clusters as characteristics, whereby plural document style decision trees can be prepared for each document style. FIG. 7 is a diagram of a decision tree that is learned to decide whether a document belongs to document style 2 or the other document styles with the style-specific frozen patterns of cluster 2 of FIG. 6 as characteristics and documents of the document style 2 including the frozen patterns and the other document styles as learned data.

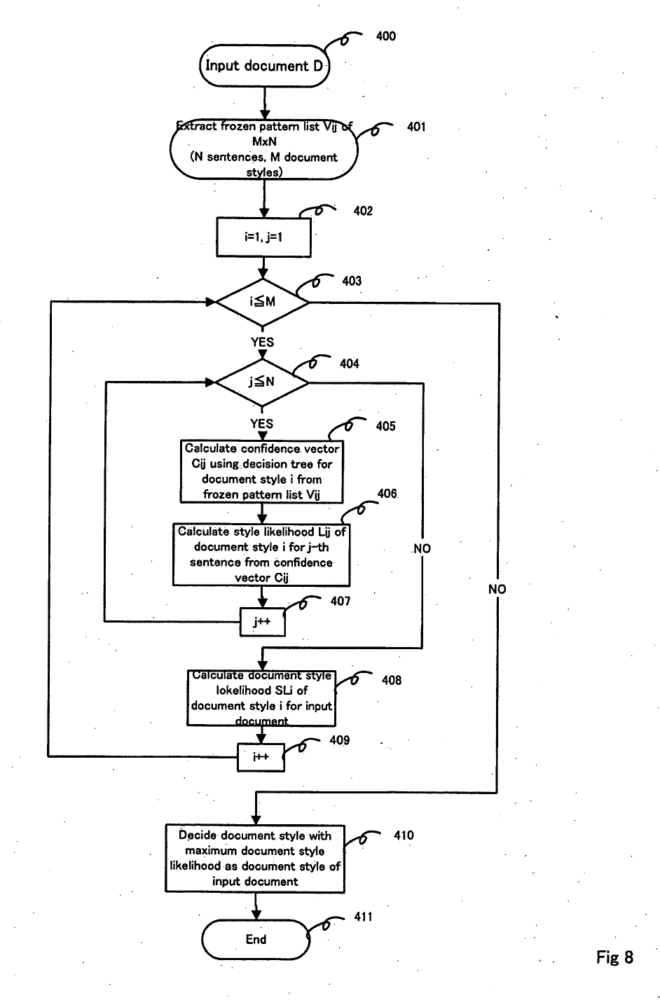

Operation of the document classifier is described herein by using the flowchart of FIG. 8.
400: Input a document D
401: Extract M×N frozen pattern lists Vᵢⱼ, where i (the number of document styles to be classified)=M and j (the number of sentences in the document=N
402: Initial setting
403: Repeat i M times
404: Repeat j N times
405: Calculate the confidence vector Cᵢⱼ by using a document style decision tree from the frozen pattern list Vᵢⱼ
406: Calculate a style likelihood Lᵢⱼ of a document style i for a j-th sentence
407: Change the variable j
408: Calculate a document style likelihood SLᵢ of the document style i for an inputted document
409: Change the variable i
410: Decide the document style with a maximum document style likelihood as the document style of the inputted document
411: End

The document classifier initially receives (during step 401), a frozen pattern list V of M×N, which is found in the information extractor of frozen pattern from the input document D. Then, in step 405, a confidence vector Cᵢⱼ=(Cᵢⱼ₁, Cᵢⱼ₂, . . . , Cᵢⱼₖ, . . . , Cᵢⱼ₁) is calculated using a document style decision tree for document style i stored in the sets of document style decision trees. Vector Cᵢⱼ is calculated from a list of frozen patterns Vᵢⱼ for the document style i. Here, Cᵢⱼₖ is the confidence of the style i that is calculated using a k-th document style decision tree from the frozen pattern list of the document style i for the j-th sentence, and 1 is the number of document style decision trees for the document style i stored in the sets of document style decision trees. In the embodiment, since the document style 2 is divided into cluster 1 and cluster 2, decision trees are found for the respective clusters, 1=2. Subsequently, in step 406, style likelihood Lᵢⱼ of document style i of the j-th sentence is calculated from the confidence vector Cᵢⱼ in accordance with:

$$\begin{matrix}\text{Expression 6} & \\ {L}_{ij} = {\sum }_{k = 1}^{k <= l} {α}_{ik} {C}_{i , k} & ( 6 )\end{matrix}$$

In Expression (6) αᵢₖ is a weighting factor representing confidence of the k-th document style decision tree for the document style i, and a value satisfying 0≦αᵢₖ≦1 and Σαᵢₖ=1 is given. The value of αᵢₖ is preferably selected to maximize the rate of correct answer for a training document with a calculated style likelihood Lᵢⱼ. The processing of steps 405 and 406 is repeated with respect to a list of frozen patterns Vᵢⱼ (1≦j≦N) for the document style i of each sentence of the input document D. A document style likelihood SLᵢ of the document style i for the inputted document is found in step 408 from N style likelihoods calculated in accordance with Expression 7.

$$\begin{matrix}\text{Expression 7} & \\ {SL}_{i} = {\sum }_{j = 1}^{j <= n} {β}_{j} {L}_{ij} & ( 7 )\end{matrix}$$

In Expression (7) Lᵢⱼ is a style likelihood of a j-th sentence for the document style i. βⱼ is a weighting factor for each sentence, and a value satisfying 0≦βⱼ≦1 and Σβⱼ=1 is given. The value of βⱼ is preferably the value that maximizes the rate of a correct answer for a training document with a calculated document style likelihood SLᵢ. This processing of steps 405 to 408 is repeated with respect to each document style i (1≦i≦M). Then, during step 410, the document style having the maximum likelihood of being the correct document style is determined to be the document style of the inputted document from M calculated document style likelihoods SL.

While there has been described and illustrated a specific embodiment of the invention, it will be clear that variations in the details of the embodiment specifically illustrated and described may be made without departing from the true spirit and scope of the invention as defined in the appended claims. For example, the invention is applicable to alphabet based languages and is not limited to character based languages, such as the given Japanese example.

1. A document classification apparatus for classifying an input document in accordance with a document style, comprising a processor arrangement for: °
(a) generating a style-specific frozen pattern for characterizing the document style;
(b) extracting a frozen pattern for characterizing a list from the input document by collating the input document with the style-specific frozen pattern;
(c) calculating confidence of the document style of the input document on the basis of the frozen pattern list; and
(d) deciding the document style to which the input document belongs on the basis of the calculated confidence.

2. The document classification apparatus according to claim 1, wherein the processor arrangement is arranged for generating a style-specific frozen pattern characterizing a document style by (a) generating a style-specific frozen pattern using the set of documents that belong to known document styles and (b) targeting an arbitrary character string present in a document on the basis of entropy of probability of character sets appearing in the front and the rear of the character string.

3. A document classification apparatus of claim 1 wherein the processor arrangement is arranged for finding a decision tree for the document style by using a set of documents that belong to known document styles, is characterized by the style-specific frozen pattern.

4. The document classification apparatus according to claim 3, wherein the processor arrangement is arranged for generating a style-specific frozen pattern characterizing a document style by (a) generating a style-specific frozen pattern using the set of documents that belong to known document styles and (b) targeting an arbitrary character string present in a document on the basis of an entropy of occurrence probability of character sets appearing in the front and the rear of the character string.

5. The document classification apparatus according to claims 4, wherein the style-specific frozen pattern is divided into plural groups, and the decision tree for document style is found with the style-specific frozen pattern for each group as a characteristic.

6. The document classification apparatus according to claim 3, wherein the style-specific frozen pattern is divided into plural groups, and the decision tree for document style is found with the style-specific frozen pattern for each group as a characteristic.

7. A style-specific frozen pattern generating apparatus for generating a style-specific frozen pattern characterizing a document style, comprising an arrangement for (a) generating the style-specific frozen pattern by using a set of documents that belong to known document styles and (b) targeting an arbitrary character string present in a document on the basis of entropy of an occurrence probability of character sets appearing in the front and the rear of the character string.

8. A document classification apparatus for classifying an input document having plural sentences in accordance with a document style, comprising a processor arrangement for:
(a) generating a style-specific frozen pattern corresponding to a document style;
(b) dividing the style-specific frozen pattern into plural groups;
(c) generating plural decision trees for document style from the style-specific frozen pattern divided into the plural groups by using a set of documents that belong to known document styles;
(d) extracting for the input document separate frozen pattern lists using the respective style-specific frozen pattern group;
(e) calculating confidence for each of the decision trees for document style corresponding to the input document on the basis of the respective frozen pattern list by using the plural decision trees for document style; and
(f) deciding document styles to which the input document belongs on the basis of the confidences.

9. A method of classifying an input document in accordance with a document style, comprising:
(a) generating a style-specific frozen pattern that characterizes the document style;
(b) extracting a frozen pattern list from the input document by collating the input document with the style-specific frozen pattern;
(c) calculating confidence of the document style of the input document on the basis of the frozen pattern list; and
(d) deciding the document style to which the input document belongs on the basis of the confidence.

10. A method of classifying an input document in accordance with a document style, comprising:
(a) generating a style-specific frozen pattern characterizing the document style;
(b) finding a decision tree for the document style by using a set of documents that belong to known document styles;
(c) extracting a frozen pattern list from the input document by collating the input document with the style-specific frozen pattern;
(d) calculating confidence of the document style of the input document on the basis of the frozen pattern list by using the decision tree for the document style; and
(e) deciding the document style to which the input document belongs on the basis of the calculated confidence.

11. A memory device or medium storing a document classification program for causing a computer to classify an input document in accordance with the method of claim 9.

12. A memory device or medium storing a document classification program for causing a computer to classify an input document in accordance with the method of claim 10.
